(19) United States
(12) Patent Application Publication
(10) Pub. No.: US 2008/0265790 A1
(43) Pub. Date: Oct. 30, 2008

(54) COUPLED LAMP DRIVING DEVICE

(76) Inventors: Cheng-Chia HSU, Chupei City (TW); Teng-Kang Chang, Jhudong Township (TW); Yu-Cheng Pan, Houdong Township (TW)

Correspondence Address: SINORICA, LLC, 528 FALLSGROVE DRIVE, ROCKVILLE, MD, 20850, US

(21) Appl. No.: 11/740,960

(22) Filed: Apr. 27, 2007

(51) Int. Cl. H05B 41/36

(52) U.S. Cl. 315/210; 315/256

(57) ABSTRACT

A coupled lamp driving device is described, comprising an alternating current (AC) power supply providing a sine-wave to two ends of each of a plurality of coupled transformers each having a primary side connected to each other at a primary side thereof and a secondary side; the plurality of coupled transformers connected to each other at the primary side thereof directing the sine-wave signal from the AC power supply to the two sides of the primary side of each of the coupled transformers and connected to an end of one of a plurality of lamps at one end of the secondary side thereof and connected to a reference level at the other end thereof, and the plurality of lamps each having the other end connected to a reference level. Since the primary sides of the coupled transformers are connected in series, a current flown on the primary side of each of the coupled transformers is equal to each other, respectively. Further, since the numbers of coils of the primary and secondary sides, respectively, are equal to each other, currents flown on the secondary side of each of the coupled transformers are also the same. Therefore, the luminance of each of the plurality of lamps can be maintained uniformly.

### BACKGROUND OF THE INVENTION

1. Field of the Invention

The present invention relates to a coupled lamp driving device, and particularly to a coupled lamp driving device capable of maintaining a uniform luminance among lamps used in a liquid crystal display (LCD) backlight source.

2. Description of the Prior Art

Referring to FIGS. 1A and 1B, in which diagrams for illustrating a circuit analysis and an analysis principle of a leakage transformer applied into a lamp driving device. As shown, the leakage transformer used in the lamp driving device may be considered as a combination of an ideal transformer 21 and a leakage of transformer 22. In the lamp driving device, a square wave signal is generated and then boosted in voltage through the ideal transformer 21. Next, the boosted square wave signal is filtered by the leakage of transformer 22 and a capacitor 16, through which a sinusoidal wave is generated, which is subsequently supplied to a lamp 11. This principle of operation of the circuit for supplying power to the lamp 11 may be applied to an implementation shown in FIG. 2, through which the purpose of a uniform luminance of the lamps in the lamp driving device can be achieved.

Referring to FIG. 2, a schematic diagram of a structure of a conventional lamp driving device is shown therein. As shown, in the conventional lamp driving device 1, a direct current (DC) power supply 12 supplies a DC power to a square-wave switch 13. The square-wave switch 13 also receives a synchronization control signal from a square-wave controller 14 and provides a square wave to a leakage transformer 15 based on the working principle mentioned above. The square-wave signal is then conversed into a sine-wave signal by means of the leakage of the leakage transformer 15 and a capacitor 16. Next, the sine-wave is used to drive a lamp 11 to operate so as to maintain the lamp to laminate uniformly.

In the above mentioned device, the leakage transformer operates by means of the leakage filtering and resonance at its secondary side. In this regard, the leakage transformer requires high leakage and high number of coils to operate. However, the higher leakage means the coupling effect is poorer. Further, the high number of the coils increase an internal resistance of the coils of the leakage transformer. Both the higher leakage and coil number contribute to a power loss and thus result in a high temperature. Further, if is it the case that a multiple of leakage transformers are used in parallel, the error of each of the leakage transformer has to be seriously controlled, so that the output of the lamps can be balanced.

Therefore, the leakage transformer has to be considered in its specification and cost in the design of the conventional lamp driving device, and thus the leakage transformer will often form a limitation in the conventional lamp driving device.

In view of the above, there exist many disadvantages in the prior art and am improved lamp driving device has to be proposed.

After years of research and studies, the inventor of the present invention set forth a coupled lamp driving device, which is taken as the present invention.

### SUMMARY OF THE INVENTION

It is, therefore, an object of the present invention to provide a coupled lamp driving device capable of effectively balancing a plurality of lamps and thus maintaining a uniform luminance over the lamps.

It is another object of the present invention to provide a coupled lamp driving device, in which a coupled transformer is used. Since it is not required to have a leakage of the transformer to filter owing to the provision of the coupled transformer, the larger the coupling coefficient is, the efficiency the better. Meanwhile, a number of coils the transformer needs not to be large and will be feasible as long as the magnetic flux of the transformer is acceptable. Since the fewer coils results in the less internal resistance, the overall efficiency can be enhanced.

It is still another object of the present invention to provide a coupled lamp driving device, which has an improved stability and lifetime and a lowered cost, dimension of the transformer spacial arrangement.

In accordance with the present invention, a coupled lamp driving device comprises an alternating current (AC) power supply providing a sine-wave to two ends of each of a plurality of coupled transformers each having a primary side connected to each other at a primary side thereof and a secondary side; the plurality of coupled transformers connected to each other at the primary side thereof directing the sine-wave signal from the AC power supply to the two sides of the primary side of each of the coupled transformers and connected to an end of one of a plurality of lamps at one end of the secondary side thereof and connected to a reference level at the other end thereof; and the plurality of lamps each having the other end connected to a reference level. Since the primary sides of the coupled transformers are connected in series, a current flown on the primary side of each of the coupled transformers is equal to each other, respectively. Further, since the numbers of coils of the primary and secondary sides, respectively, are equal to each other, currents flown on the secondary side of each of the coupled transformers are also the same. Therefore, the luminance of each of the plurality of lamps can be maintained uniformly.

### BRIEF DESCRIPTION OF THE DRAWINGS

The drawings disclose illustrative embodiments of the present invention which serve to exemplify the various advantages and objects hereof, and are as follows:

FIG. 1A is a circuit analysis diagram for illustrating a conventional lamp driving device in which a leakage transformer is used;

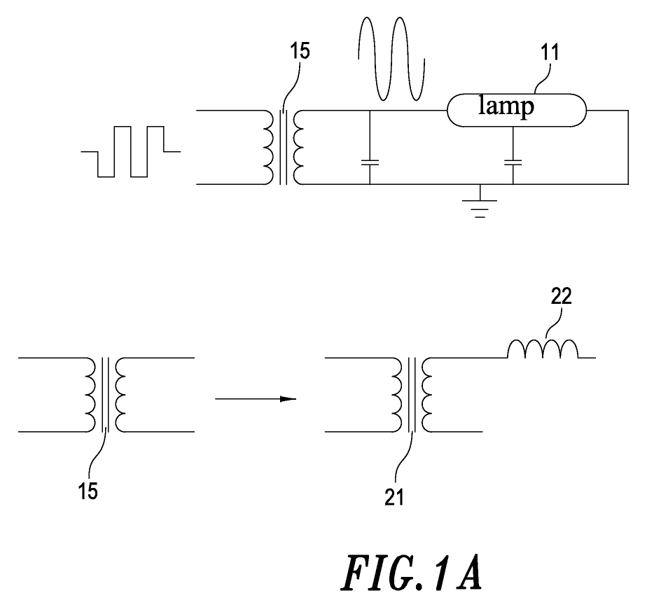

FIG. 1B is an analysis principle diagram for illustrating a conventional lamp driving device in which a leakage transformer is used;

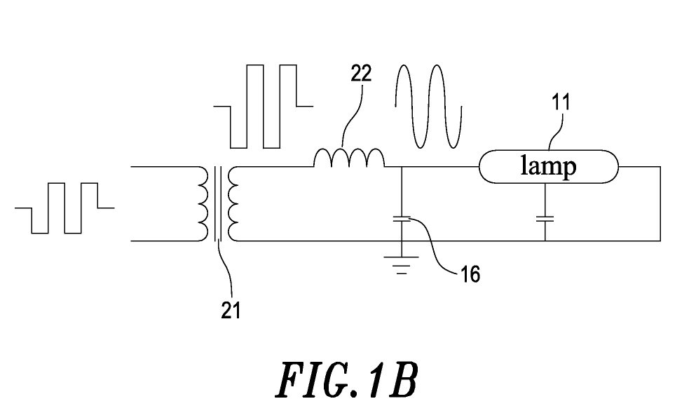

FIG. 2 is a structure of a conventional lamp driving device;

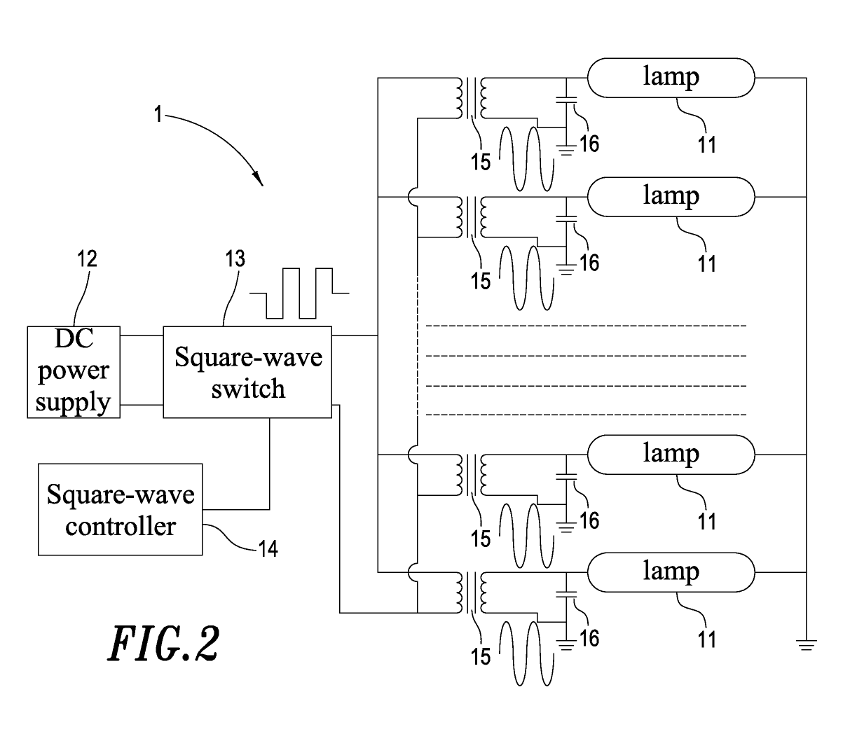

FIG. 3 is a circuit diagram of a coupled lamp driving device according to a first embodiment of the present invention;

FIG. 4 is a circuit diagram of the coupled lamp driving device according to a second embodiment of the present invention;

FIG. 5A is a circuit diagram of an implementation of the coupled lamp driving device shown in FIG. 4 in which a blocking capacitor is additionally provided;

FIG. 5B is a circuit diagram of an implementation of the coupled lamp driving device shown in FIG. 4 in which a blocking capacitor is additionally provided;

FIG. 5C is a circuit diagram of an implementation of the coupled driving device shown in FIG. 4 through which a multiple lamps are driven to operate;

FIG. 6 is a circuit diagram of the coupled lamp driving device according to a third embodiment of the present invention;

FIG. 7 is a circuit diagram of an implementation of the coupled lamp driving device shown in FIG. 6, in which an inductor is additionally provided; and

FIG. 8 is a circuit diagram of an implementation of the coupled lamp driving device shown in FIG. 6, through which a multiple lamps are driven to operate.

### DETAILED DESCRIPTION OF THE PREFERRED EMBODIMENT

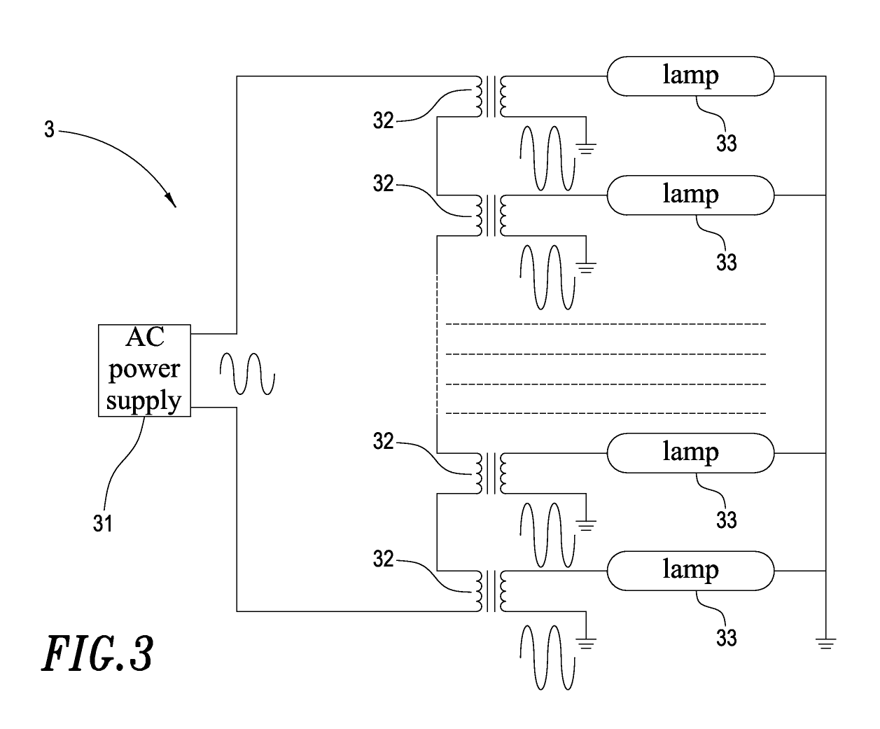

Referring to FIG. 3, a circuit diagram of a coupled lamp driving device according to a first embodiment of the present invention is shown therein. As shown, the lamp driving device 3 comprises an alternating current (AC) power supply 31, which provides a sine-wave signal to two ends of each of a plurality of coupled transformers 32 connected to each other at their primary sides. Through the plurality of coupled transformers 32 connected at their primary sides, the sine-wave signal is directed to the two ends of the primary side of each of the coupled transformer 32. A secondary side of the coupled transformer 32 is connected to a high voltage end of a lamp 33 at one end, and connected to a reference level at the other end. Since the primary sides of the coupled transformers 32 are connected in series, a current flown on the primary side of each of the coupled transformers 32 is equal to each other, respectively. Further, since the numbers of coils of the primary and secondary sides, respectively, are equal to each other, currents flown on the secondary side of each of the coupled transformers 32 are also the same.

Each of a plurality of lamps 33 has a high voltage end connected to one end of the secondary side of a respective one of the coupled transformers 32, and a low voltage end connected to a reference level.

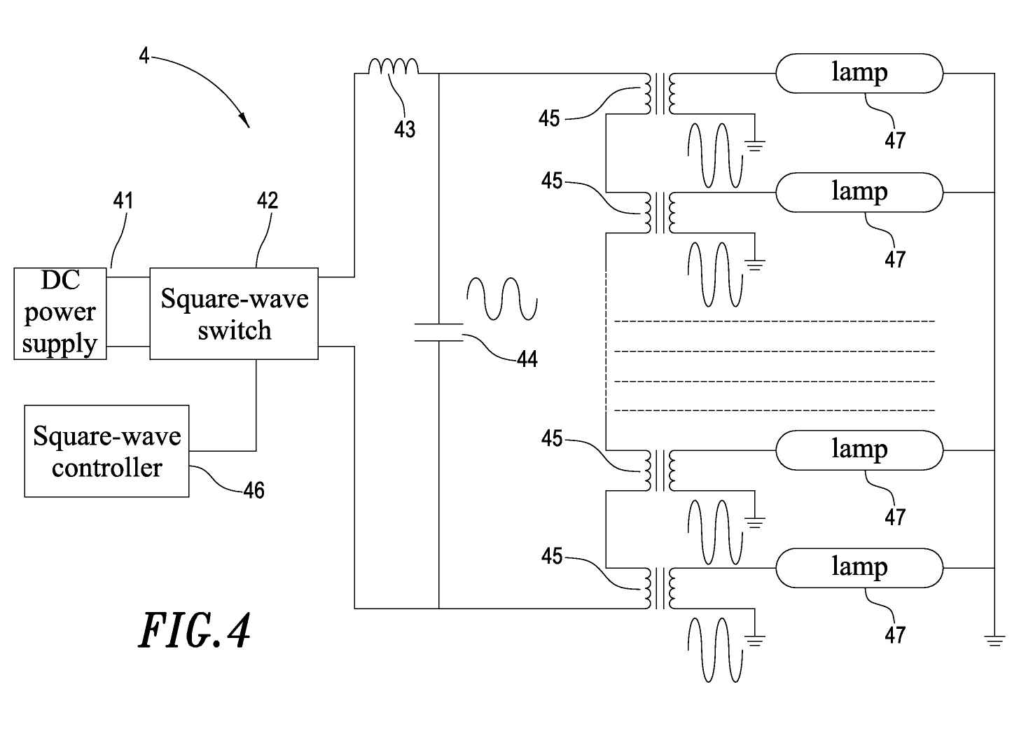

Referring to FIG. 4, a circuit diagram of the coupled lamp driving device according to a second embodiment of the present invention is shown therein. As shown, the coupled lamp driving device 4 comprises a direct current a direct current (DC) power supply 41 which outputs a DC power. The square-wave switch 42 is used to receives the DC power, convert the DC power into a square-wave signal and then a sine-wave signal through an inductor 43 and a capacitor 44, and then provides the sine-wave signal to two ends of each of a plurality of coupled transformers 45 connected at a primary side thereof.

A square-wave controller 46 is used to output a control signal to the square-wave switch 42.

Each of the plurality of coupled transformers 45 is connected to each other at the primary side thereof and directs the sine-wave signal obtained through the inductor 43 and the capacitor 44 to the two ends of the primary side of each of the plurality of coupled transformers 45 and connected to one end, a high voltage end, of a respective of a plurality of lamps at one end of the secondary side thereof and connected to a reference level at the other end thereof. Since the coupled transformers 45 are connected in series at their primary sides, a current flown on the primary side of each of the plurality of coupled transformers 45 is equal to each other. Further, since the coil numbers provided at the primary and secondary of each of the coupled transformers 45 are the same, an output current flown on the secondary side of each of the coupled transformers 45 is equal to each other.

The plurality of lamps 45 each have the other end, a low voltage end, connected to a reference level.

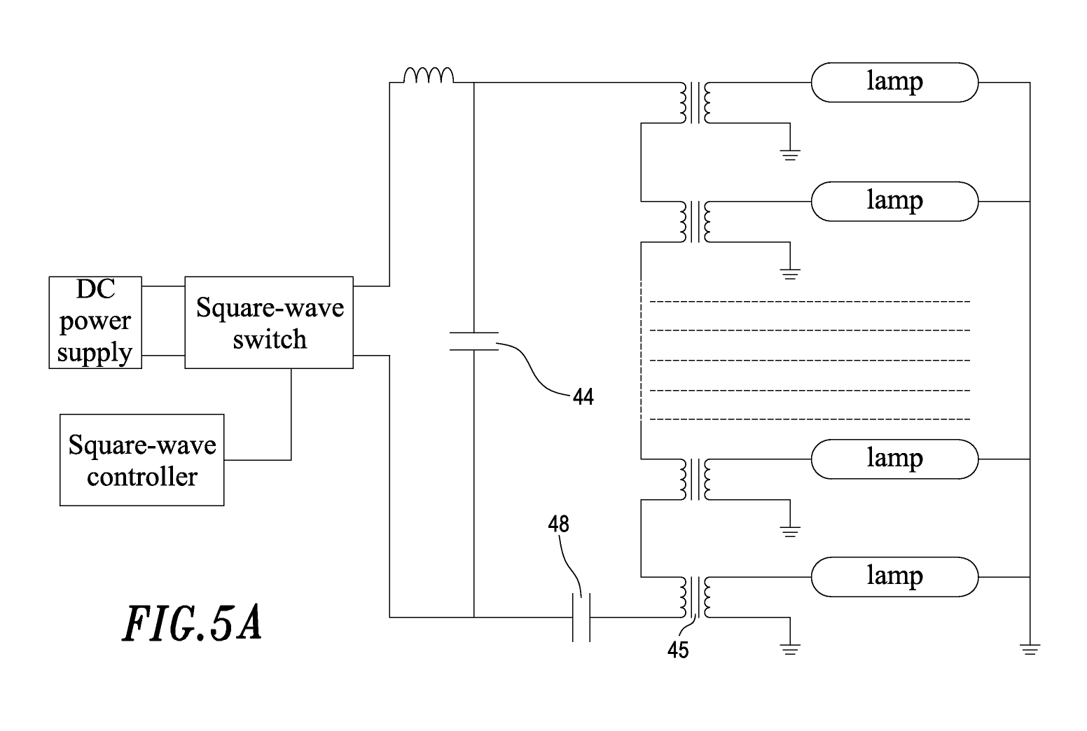

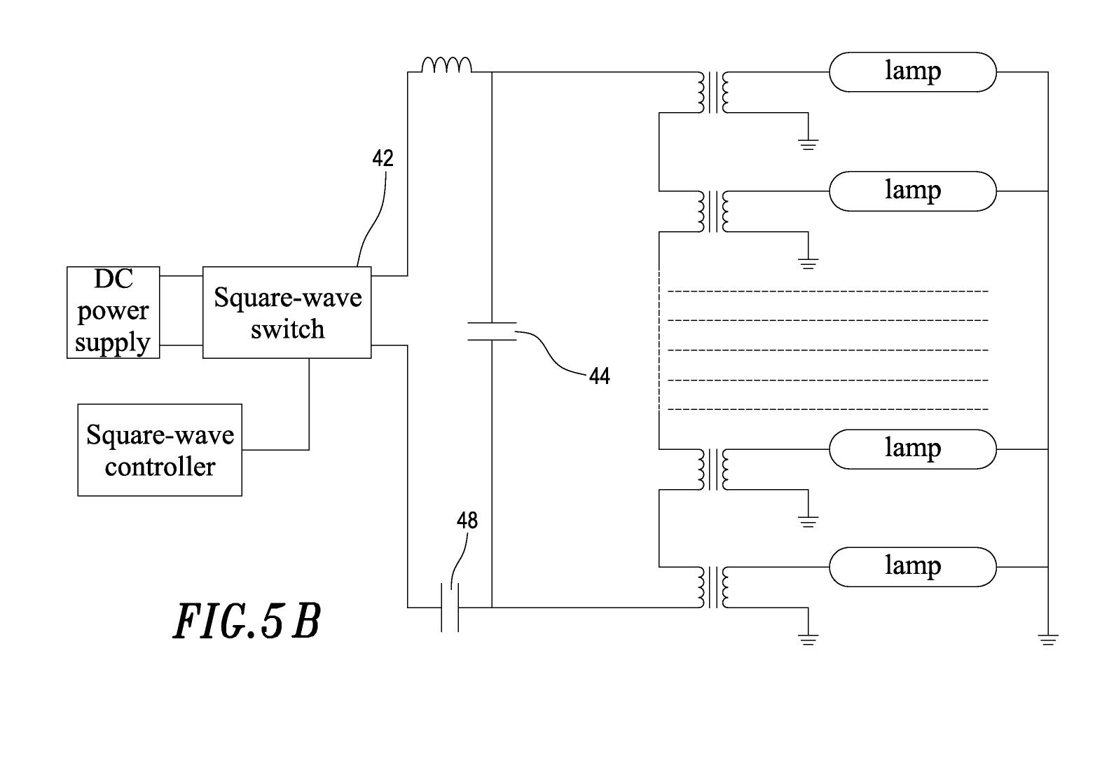

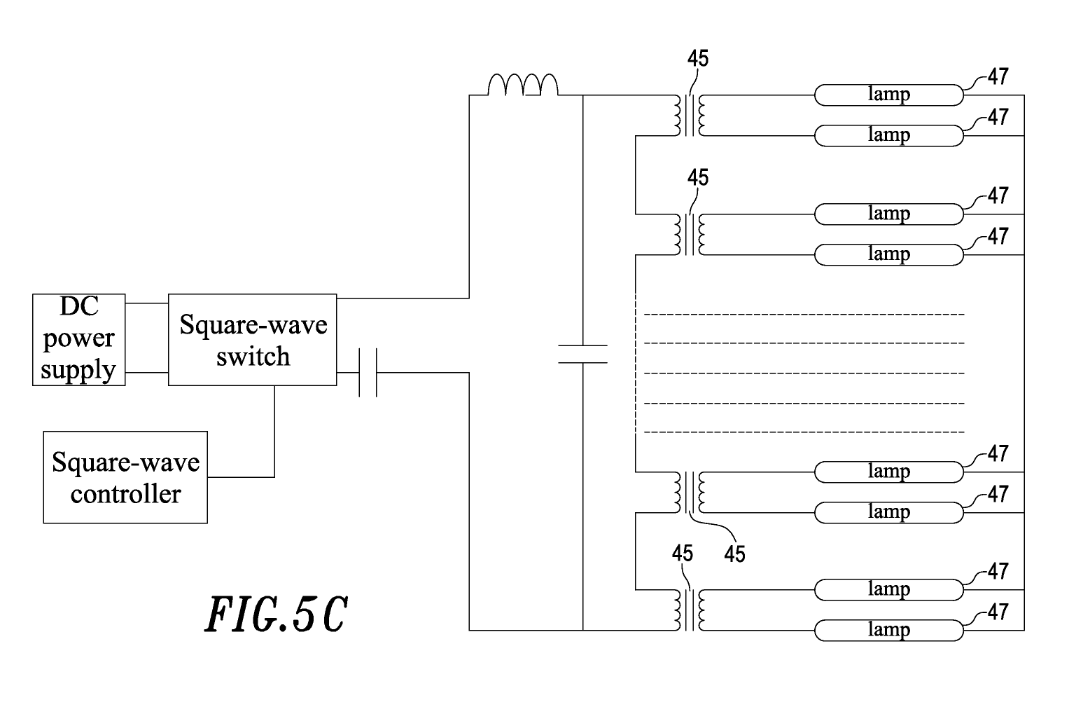

Referring to FIGS. 5A and 5B, circuit diagrams of implementations of the coupled lamp driving device shown in FIG. 4 are respectively shown, each having a blocking capacitor provided, which are used for blocking a DC noise. In FIG. 5A, it is shown that the blocking capacitor 48 is additionally provided between the capacitor and the coupled transformer. In FIG. 5B, it is shown that the blocking capacitor 48 is additionally provided between the square-wave switch and the capacitor.

FIG. 5C is a circuit diagram of an implementation of the coupled driving device shown in FIG. 4 through which a multiple lamps are driven to operate. As shown, each of the two ends of the secondary side of each of the coupled transformer 55 is connected to a high voltage end of each of two lamps. A low voltage end of each of the lamps is connected to each other, respectively. As such, the purpose of driving the multiple of lamps is achieved.

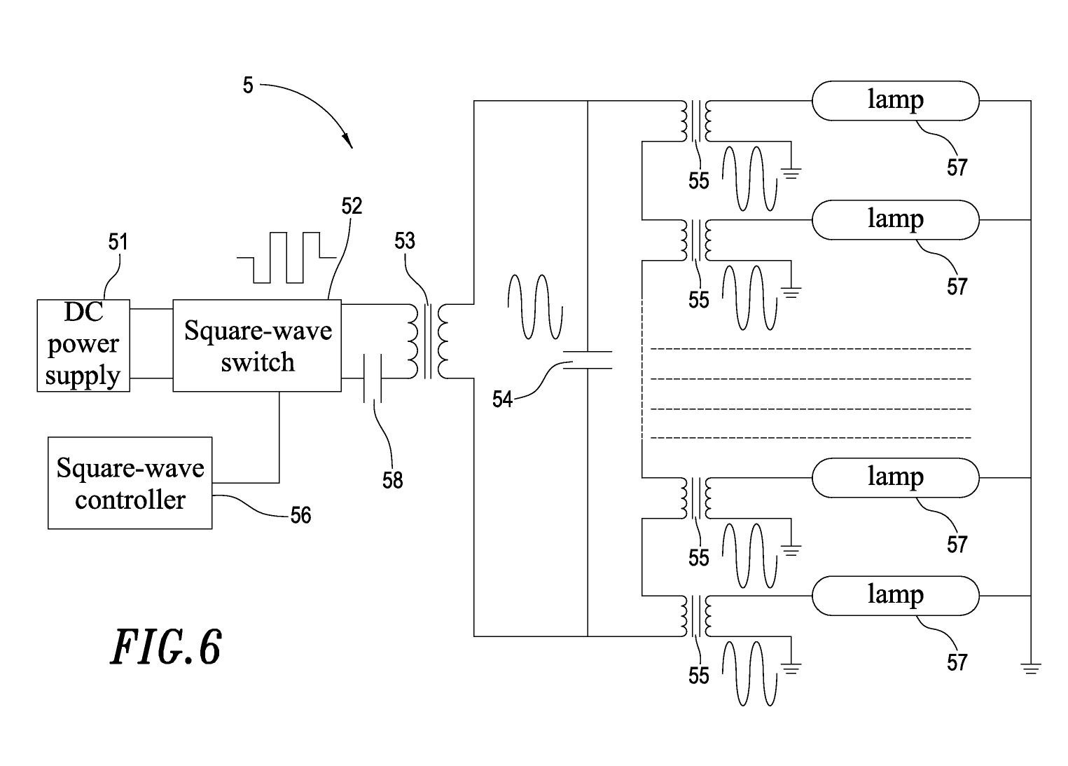

FIG. 6 is a circuit diagram of the coupled lamp driving device according to a third embodiment of the present invention. As shown, the coupled lamp driving device. As shown the coupled lamp driving device 50 comprises a direct current (DC) power supply 51, which outputs a DC power;

A square-wave switch 52 is used to receive the DC power, convert the DC power into a square-wave signal and then output the square-wave signal.

The driving transformer 53 is used to receive the square-wave signal from the square-wave switch 52 at a primary side thereof. Between the square-wave switch 52 and the driving transformer 53, a capacitor 58 may be disposed for blocking a DC noise. Further, the driving transformer 53 converts the square-wave signal into a sine-wave signal through a leakage thereof (not shown) and a capacitor 54, and provides the sine-wave signal to two ends of each of a plurality of coupled transformers 55 connected to each other at a primary side thereof.

A square-wave controller 56 is used to output a control signal to the square-wave switch 52.

The plurality of coupled transformers 55 connected to each other at the primary side is used to direct the sine-wave signal obtained through the driving transformer 53 and the capacitor 54 to the two ends of the primary side of each of the plurality of coupled transformers 55 and connected to an end of one of a plurality of lamps 57 at one end of the secondary side thereof and connected to a reference level at the other end thereof. Since the primary sides of the coupled transformer 55 are connected in series, a current flown on each of the coupled transformers are equal to each other, respectively. Further, since the numbers of coils of the primary and secondary sides of the coupled transformer 55, respectively, are equal to each other, currents flown on the secondary side of each of the coupled transformers 55 are also the same. Therefore, the luminance of each of the plurality of lamps 57 can be maintained uniformly.

The plurality of lamps each having the other end connected to a reference level.

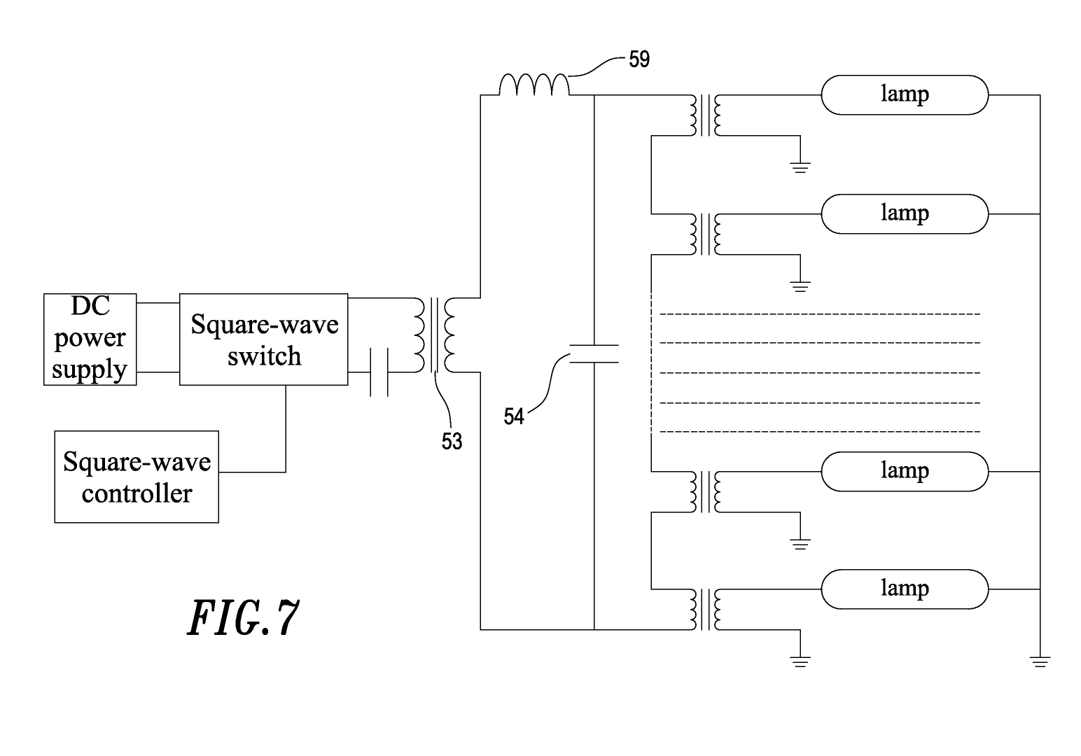

FIG. 7 is a circuit diagram of an implementation of the coupled lamp driving device shown in FIG. 6, in which an inductor is additionally provided. As shown, an inductor 59 is additionally provided between the driving transformer 53 and the capacitor 54, so as to converting the square-wave signal into the sine-wave signal in cooperation with the capacitor 54.

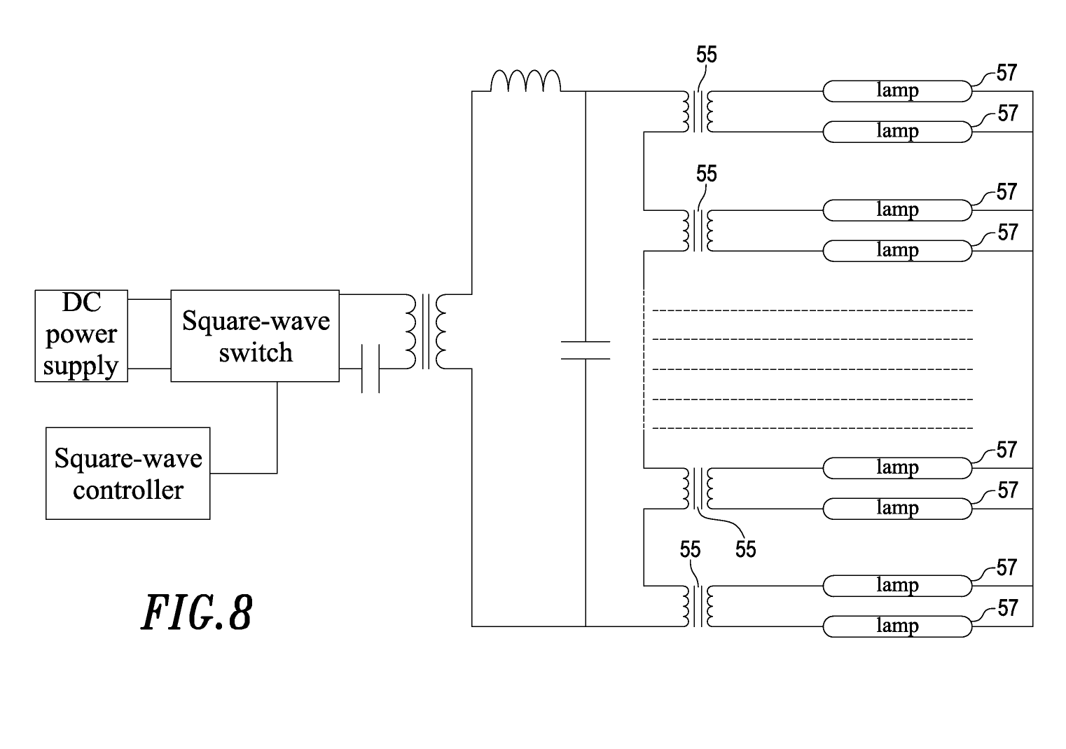

FIG. 8 is a circuit diagram of an implementation of the coupled lamp driving device shown in FIG. 6, through which a multiple lamps are driven to operate. As shown, each of the lamps 57 has a high voltage end for connection to one respective of the two ends of the secondary side of the coupled transformer 55, and respective low voltage ends of the lamps 57 are connected together. As such, the multiple lamps can be driven to operate together.

Compared with the prior art, the coupled lamp driving device has the following advantages. 1. The plurality of lamps can be effectively balanced in the coupled driving device of the present invention, achieving the goal of maintaining a uniform luminance over the lamps. 2. Since it is not required to have the leakage of the transformer to filter owing to the provision of the coupled transformer in the present invention, the larger the coupling coefficient is, the efficiency the better. Meanwhile, the coil number of the transformer needs not to be large and will be feasible as long as the magnetic flux of the transformer is acceptable. Since the fewer coils results in the less internal resistance, the overall efficiency can be enhanced. 3. The coupled lamp driving device has an improved stability and lifetime and a lowered cost, dimension of the transformer spacial arrangement.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A coupled lamp driving device, comprising:
an alternating current (AC) power supply providing a sine-wave to two ends of each of a plurality of coupled transformers each having a primary side connected to each other at a primary side thereof and a secondary side;
the plurality of coupled transformers connected to each other at the primary side thereof directing the sine-wave signal from the AC power supply to the two sides of the primary side of each of the coupled transformers and connected to an end of one of a plurality of lamps at one end of the secondary side thereof and connected to a reference level at the other end thereof, and the plurality of lamps each having the other end connected to a reference level.

2. A coupled lamp driving device, comprises:
a direct current (DC) power supply outputting a DC power;
a square-wave switch receiving the DC power, converting the DC power into a square-wave signal and then a sine-wave signal through an inductor and a capacitor and then providing the sine-wave signal to two ends of each of a plurality of coupled transformers connected at a primary side thereof;
a square-wave controller outputting a control signal to the square-wave switch;
the plurality of coupled transformers each connected to each other at the primary side directing the sine-wave signal to the two ends of the primary side of each of the plurality of coupled transformers and connected to an end of one of a plurality of lamps at one end of the secondary side thereof and connected to a reference level at the other end thereof, and
the plurality of lamps each having the other end connected to a reference level.

3. The coupled driving device as claimed in claim 1, a blocking capacitor is connected between the capacitor and the coupled transformer for blocking a DC noise flowing therebetween.

4. The coupled driving device as claimed in claim 2, a blocking capacitor is connected between the capacitor and the coupled transformer for blocking a DC noise flowing therebetween.

5. The coupled driving device as claimed in claim 2, wherein a lamp is connected at a respective one of the two ends of the secondary side of each of the plurality of coupled transformers.

6. The coupled driving device as claimed in claim 3, wherein a lamp is connected at a respective one of the two ends of the secondary side of each of the plurality of coupled transformers.

7. The coupled driving device as claimed in claim 4, wherein a lamp is connected at a respective one of the two ends of the secondary side of each of the plurality of coupled transformers.

8. A coupled lamp driving device, comprises:
a direct current (DC) power supply outputting a DC power;
receiving the DC power, converting the DC power into a square-wave signal and then outputting the square-wave signal;
a driving transformer receiving the square-wave signal from the square-wave switch at a primary side thereof, converting the square-wave signal into a sine-wave signal through a leakage thereof and a capacitor, and providing the sine-wave signal to two ends of each of a plurality of coupled transformers connected to each other at a primary side thereof;
a square-wave controller outputting a control signal;
the plurality of coupled transformers connected to each other at the primary side directing the sine-wave signal to the two ends of the primary side of each of the plurality of coupled transformers and connected to an end of one of a plurality of lamps at one end of the secondary side thereof and connected to a reference level at the other end thereof; and
the plurality of lamps each having the other end connected to a reference level.

9. The coupled driving device as claimed in claim 8, a blocking capacitor is connected between the capacitor and the coupled transformer for blocking a DC noise flowing therebetween.

10. The coupled lamp driving device as claimed in claim 8, wherein an inductor is connected between the driving transformer and the capacitor so as to converting the square-wave signal into the sine-wave signal.

11. The coupled lamp driving device as claimed in claim 9, wherein an inductor is connected between the driving transformer and the capacitor so as to converting the square-wave signal into the sine-wave signal.

12. The coupled driving device as claimed in claim 8, wherein a lamp is connected at a respective one of the two ends of the secondary side of each of the plurality of coupled transformers.

13. The coupled driving device as claimed in claim 9, wherein a lamp is connected at a respective one of the two ends of the secondary side of each of the plurality of coupled transformers.

14. The coupled driving device as claimed in claim 10, wherein a lamp is connected at a respective one of the two ends of the secondary side of each of the plurality of coupled transformers.

15. The coupled driving device as claimed in claim 11, wherein a lamp is connected at a respective one of the two ends of the secondary side of each of the plurality of coupled transformers.
